(19) United States
(12) Patent Application Publication
(10) Pub. No.: US 2014/0349911 A1
(43) Pub. Date: Nov. 27, 2014

(54) LOW PH MULTIPURPOSE CLEANING COMPOSITION

(71) Applicant: The Procter & Gamble Company, Cincinnati, OH (US)

(72) Inventors: Brandon Douglas GADDIS, Cincinnati, OH (US); Gayle Marie FRANKENBACH, Cincinnati, OH (US)

(73) Assignee: The Procter & Gamble Company, Cincinnati, OH (US)

(21) Appl. No.: 14/284,416

(22) Filed: May 22, 2014

Related U.S. Application Data
(60) Provisional application No. 61/827,131, filed on May 24, 2013.

(51) Int. Cl. C11D 1/83

(52) U.S. Cl. CPC C11D 1/83
USPC 510/405

(57) ABSTRACT

Cleaning compositions and, more specifically, to concentrated multipurpose cleaning compositions suitable for washing of clothes and also suitable for use on hair and skin. Methods of making and using the same.

### FIELD OF THE INVENTION

The present disclosure relates generally to cleaning compositions and, more specifically, to multipurpose cleaning compositions suitable for washing clothes as well as hair and skin. The disclosure also relates to methods of making and using the same.

### BACKGROUND OF THE INVENTION

Numerous cleaning compositions are available for use by consumers for washing clothing and other fabrics in traditional washing machines. However, in many parts of the world, especially where average household income is as low as US $2 per day and/or available water supply is limited, traditional washing machines remain unaffordable luxury items. In some countries and remote villages, for example, clothing articles typically are washed by hand in a bucket, using available laundry soap bars and powders. The washing by hand may involve rubbing or abrading the clothing articles, such as with a washboard or stone, and the water used for the washing may be exceptionally hard or even polluted. Often, where water is scarce, the same water used to wash the clothing articles will be reused to wash skin and hair of one or more family members.

Typical consumer laundry cleaning compositions are not indicated for use on skin and hair. Unlike common body soaps, shampoos, and other toiletry products that are tailored for such applications, consumer laundry cleaning compositions usually contain one or more ingredients that will cause skin or eye irritation. The high pH of typical laundry powders and bars contributes to redness, irritation, and water loss in skin. High pH products are traditionally used in laundry, because high pH enables the use of traditional builders and surfactants.

Therefore, there is a need for a multipurpose cleaning composition that is mild, effective, and economical, e.g., a product that provides superior laundry cleaning and is also mild enough to use on hair and skin.

Concentrated cleaning compositions are also desirable. For example, reducing the water content of a composition may reduce shipping and/or storage costs. More viscous cleaning compositions may also connote added value and/or cleaning capabilities to a consumer. Concentrated cleaning compositions may be used in neat form, or they may be diluted by a supplier, a vendor, or a consumer, prior to use.

Concentrated cleaning compositions, however, can present a number of challenges. For example, the active components of a concentrated cleaning composition may precipitate. The concentrated composition may not be phase stable, resulting in an undesirable separation of components. High viscosities can make the concentrated composition difficult to process or use. Furthermore, the concentrated composition may not be readily dilutable, resulting in a diluted product that has an undesirable viscosity and/or is not phase stable.

Altogether, there is a need for a concentrated multipurpose cleaning composition that is readily dilutable. It has been surprisingly discovered that a concentrated multipurpose cleaning composition that is readily dilutable may be obtained in a low pH system by selecting certain surfactants in certain concentrations and ratios.

### SUMMARY OF THE INVENTION

The present invention attempts to solve one or more of the needs by providing, in some aspects, a concentrated multipurpose liquid cleaning composition comprising: from about 20% to about 55% by weight of the cleaning composition of at least one anionic surfactant; from about 5% to about 30% by weight of the cleaning composition of at least one nonionic surfactant; and from about 0.5% to about 8% by weight of the cleaning composition of at least one organic acid, where each organic acid in the composition has fewer than 9 carbon atoms; where the cleaning composition comprises from about 25% to about 60% by weight of the cleaning composition of total surfactant; and where the cleaning composition has a neat pH of from about 2 to about 6.9.

In other aspects, the present invention provides a multipurpose liquid cleaning composition consisting essentially of: from about 21% to about 53%, by weight of the composition, of anionic surfactant comprising alkyl benzene sulfonic acids and their salts; from about 7% to about 25%, by weight of the composition, of nonionic surfactant comprising C12-C18 alkyl ethoxylates; from about 1% to about 6%, by weight of the composition, of organic acid, where the organic acid has 6 or fewer carbons; optionally, perfume; optionally, dye; and water; where the multipurpose liquid cleaning composition has a neat pH of from about 3 to about 5.

In other aspects, the present disclosure provides a method of cleaning a surface comprising the steps of contacting the surface with a cleaning composition according to the present invention and washing the surface. The method may further comprise the step of diluting the cleaning composition.

### DETAILED DESCRIPTION OF THE INVENTION

As used herein, the articles “a” and “an” when used in a claim, are understood to mean one or more of what is claimed or described.

As used herein, the terms “include,” “includes,” and “including” are meant to be non-limiting.

As used herein, “low pH cleaning composition” refers to a cleaning composition having a pH of less than about 7 and greater than about 1.

The compositions of the present invention can comprise, consist essentially of, or consist of, the components of the present disclosure.

Unless otherwise noted, all percentages are by weight of the concentrated cleaning composition.

Unless otherwise noted, all component or composition levels are in reference to the active portion of that component or composition, and are exclusive of impurities, for example, residual solvents or by-products, which may be present in commercially available sources of such components or compositions.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Multipurpose Cleaning Composition

The present disclosure relates to concentrated multipurpose cleaning compositions. The concentrated multipurpose cleaning compositions disclosed herein are generally low-pH compositions and may be used on fabric, hair, and/or skin. The cleaning compositions comprise surfactant and organic acid. In some aspects, the compositions have viscosities of from about 500 mPa*s to about 13,000 mPa*s at 1 s⁻¹, as measured at 25.0° C. using an AR2000 viscometer (TA Instruments of New Castle, Del.) using an acrylic 60 mm, 2° flat cone. Viscosity can also be determined by other conventional methods readily known in the art.

In some aspects, the cleaning compositions of the invention comprise from about 30% to about 60%, or from about 40% to about 55%, or from about 45% to about 50%, water by weight of the composition. In some aspects, the cleaning compositions comprise less than about 55%, or less than about 50%, or less than about 40%, or less than about 20%, water by weight of the composition.

The cleaning compositions of the present invention may be in liquid, gel, or paste form. In some aspects, the composition is in unit dose form, where the composition is encapsulated in a water-soluble film or pouch. The water-soluble film or pouch may comprise polyvinyl alcohol, polyvinyl acetate, or mixtures thereof. The unit dose form may comprise at least two compartments or at least three compartments. At least one compartment of the unit dose form may be superimposed on another compartment.

The components of the cleaning compositions, as well as their preparation and use, are described in greater detail as follows.

### Surfactant

The cleaning compositions described herein comprise from about 25% to about 60%, or from about 35% to 55%, or from about 39% to about 53%, or from about 39% to about 47%, or from about 40% to about 52% by weight of the cleaning composition of surfactant.

The surfactant may be selected from anionic surfactants, nonionic surfactants, amphoteric surfactants, zwitterionic surfactants, cationic surfactants, or mixtures thereof. In some aspects, the cleaning composition comprises surfactant selected from anionic surfactant, nonionic surfactant, or mixtures thereof.

### Anionic Surfactant

The composition may comprise at least one anionic surfactant. In some aspects, the composition comprises, by weight of the cleaning composition, from about 20% to about 55%, or from about 21% to about 53%, or from about 23% to about 50%, or from about 23.5% to about 44%, or from about 24% to about 35% of at least one anionic surfactant. It is understood that the acid forms of the anionic surfactants described herein may be neutralized with an appropriate alkalizing agent, such as sodium hydroxide or monoethanolamine; as used herein, the anionic surfactant may be present in acid form and/or in salt form.

Non-limiting examples of suitable anionic surfactants include alkyl benzene sulfonic acids and their salts. In some aspects, the anionic surfactant comprises, or even consists of, linear alkyl benzene sulfonic acid. In some aspects, the compositions are substantially free of alkyl sulfate surfactants, alkyl akloxylated sulfate surfactants, and mixtures thereof.

Exemplary anionic surfactants are the C₁₀-C₁₆ alkyl benzene sulfonic acids, or C₁₁-C₁₄ alkyl benzene sulfonic acids, and their respective alkali metal salts. In some aspects, the alkyl group is linear; such linear alkyl benzene sulfonates are known as “LAS.” Alkyl benzene sulfonates, and particularly LAS, are well known in the art. Such surfactants and their preparation are described for example in U.S. Pat. Nos. 2,220,099 and 2,477,383. Especially useful are the sodium and potassium linear straight chain alkylbenzene sulfonates in which the average number of carbon atoms in the alkyl group is from about 11 to 14. Sodium C₁₁-C₁₄, e.g., C₁₂, LAS is a specific example of such surfactants. In some aspects, the linear alkyl benzene sulfonic acid is a C11.8 linear alkyl benzene sulfonic acid.

Useful anionic surfactants also include the water-soluble salts, particularly the alkali metal, ammonium and alkylolammonium (e.g., monoethanolammonium or triethanolammonium) salts, of organic sulfuric reaction products having in their molecular structure an alkyl group containing from about 10 to about 20 carbon atoms and a sulfonic acid group. (Included in the term “alkyl” is the alkyl portion of aryl groups.) Other anionic surfactants useful herein are the water-soluble salts of: paraffin sulfonates and secondary alkane sulfonates containing from about 8 to about 24 (preferably about 12 to 18) carbon atoms; alkyl glyceryl ether sulfonates, especially those ethers of C₈₋₁₈ alcohols (e.g., those derived from tallow and coconut oil).

Mixtures of the alkylbenzene sulfonates with the above-described paraffin sulfonates, secondary alkane sulfonates and alkyl glyceryl ether sulfonates are also useful.

Although alkyl benzene sulfonic acids are preferred, in some aspects another exemplary type of anionic surfactant includes ethoxylated alkyl sulfate surfactants. Such materials, also known as alkyl ether sulfates (AES) or alkyl polyethoxylate sulfates, are those which correspond to the formula: R′—O—(C₂H₄O)ₙ—SO₃M wherein R′ is a C₈-C₂₀ alkyl group, n is from about 1 to 20, and M is a salt-forming cation. In a specific embodiment, R′ is C₁₀-C₁₈ alkyl, n is from about 1 to 15, and M is sodium, potassium, ammonium, alkylammonium, or alkanolammonium. In more specific embodiments, R′ is a C₁₂-C₁₆, n is from about 1 to 6 and M is sodium.

The alkyl ether sulfates will generally be used in the form of mixtures comprising varying R′ chain lengths and varying degrees of ethoxylation. Frequently such mixtures will inevitably also contain some non-ethoxylated alkyl sulfate (AS) materials, i.e., surfactants of the above ethoxylated alkyl sulfate formula wherein n=0. Non-ethoxylated alkyl sulfates may also be added separately to the compositions of this invention and used as or in any anionic surfactant component which may be present. Specific examples of non-alkoyxylated, e.g., non-ethoxylated, alkyl sulfate surfactants are those produced by the sulfation of higher C₈-C₂₀ fatty alcohols. Conventional primary alkyl sulfate surfactants have the general formula: ROSO₃⁻M⁺ wherein R is typically a C₈-C₂₀ alkyl group, which may be straight chain or branched chain, and M is a water-solubilizing cation. In specific embodiments, R is a C₁₀-C₁₅ alkyl group, and M is alkali metal, more specifically R is C₁₂-C₁₄ alkyl and M is sodium.

In some aspects, the anionic surfactant may be a branched surfactant. Suitable branched detersive surfactants include anionic branched surfactants selected from branched sulphate or branched sulphonate surfactants, e.g., branched alkyl sulphate, branched alkyl alkoxylated sulphate, and branched alkyl benzene sulphonates, comprising one or more random alkyl branches, e.g., C₁₋₄ alkyl groups, typically methyl and/or ethyl groups.

In some aspects, the branched detersive surfactant is a mid-chain branched detersive surfactant, typically, a mid-chain branched anionic detersive surfactant, for example, a mid-chain branched alkyl sulphate and/or a mid-chain branched alkyl benzene sulphonate. In some aspects, the detersive surfactant is a mid-chain branched alkyl sulphate. In some aspects, the mid-chain branches are C₁₋₄ alkyl groups, typically methyl and/or ethyl groups.

In some aspects, the branched surfactant comprises a longer alkyl chain, mid-chain branched surfactant compound of the formula:

A_{b}-X—B

where:
(a) A_{b} is a hydrophobic C9 to C22 (total carbons in the moiety), typically from about C12 to about C18, mid-chain branched alkyl moiety having: (1) a longest linear carbon chain attached to the —X—B moiety in the range of from 8 to 21 carbon atoms; (2) one or more C1-C3 alkyl moieties branching from this longest linear carbon chain; (3) at least one of the branching alkyl moieties is attached directly to a carbon of the longest linear carbon chain at a position within the range of position 2 carbon (counting from carbon #1 which is attached to the —X—B moiety) to position ω-2 carbon (the terminal carbon minus 2 carbons, i.e., the third carbon from the end of the longest linear carbon chain); and (4) the surfactant composition has an average total number of carbon atoms in the A_{b}-X moiety in the above formula within the range of greater than 14.5 to about 17.5 (typically from about 15 to about 17);
b) B is a hydrophilic moiety selected from sulfates, sulfonates, amine oxides, polyoxyalkylene (such as polyoxyethylene and polyoxypropylene), alkoxylated sulfates, polyhydroxy moieties, phosphate esters, glycerol sulfonates, polygluconates, polyphosphate esters, phosphonates, sulfosuccinates, sulfosuccaminates, polyalkoxylated carboxylates, glucamides, taurinates, sarcosinates, glycinates, isethionates, dialkanolamides, monoalkanolamides, monoalkanolamide sulfates, diglycolamides, diglycolamide sulfates, glycerol esters, glycerol ester sulfates, glycerol ethers, glycerol ether sulfates, polyglycerol ethers, polyglycerol ether sulfates, sorbitan esters, polyalkoxylated sorbitan esters, ammonioalkanesulfonates, amidopropyl betaines, alkylated quats, alkylated/polyhydroxyalkylated quats, alkylated/polyhydroxylated oxypropyl quats, imidazolines, 2-yl-succinates, sulfonated alkyl esters, and sulfonated fatty acids (it is to be noted that more than one hydrophobic moiety may be attached to B, for example as in (A_{b}-X)_{z}—B to give dimethyl quats); and
(c) X is selected from —CH₂— and —C(O)—.

Generally, in the above formula the A_{b} moiety does not have any quaternary substituted carbon atoms (i.e., 4 carbon atoms directly attached to one carbon atom). Depending on which hydrophilic moiety (B) is selected, the resultant surfactant may be anionic, nonionic, cationic, zwitterionic, amphoteric, or ampholytic. In some aspects, B is sulfate and the resultant surfactant is anionic.

In some aspects, the branched surfactant comprises a longer alkyl chain, mid-chain branched surfactant compound of the above formula wherein the A_{b} moiety is a branched primary alkyl moiety having the formula:

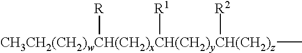

wherein the total number of carbon atoms in the branched primary alkyl moiety of this formula (Including the R, R¹, and R² branching) is from 13 to 19; R, R1, and R2 are each independently selected from hydrogen and C1-C3 alkyl (typically methyl), provided R, R1, and R2 are not all hydrogen and, when z is 0, at least R or R1 is not hydrogen; w is an integer from 0 to 13; x is an integer from 0 to 13; y is an integer from 0 to 13; z is an integer from 0 to 13; and w+x+y+z is from 7 to 13.

In certain aspects, the branched surfactant comprises a longer alkyl chain, mid-chain branched surfactant compound of the above formula wherein the A_{b} moiety is a branched primary alkyl moiety having the formula selected from:

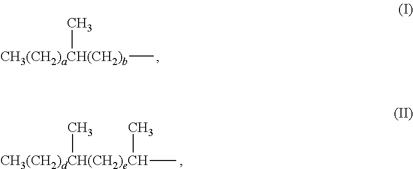

or mixtures thereof; wherein a, b, d, and e are integers, a+b is from 10 to 16, d+e is from 8 to 14 and wherein further
when a+b=10, a is an integer from 2 to 9 and b is an integer from 1 to 8;
when a+b=11, a is an integer from 2 to 10 and b is an integer from 1 to 9;
when a+b=12, a is an integer from 2 to 11 and b is an integer from 1 to 10;
when a+b=13, a is an integer from 2 to 12 and b is an integer from 1 to 11;
when a+b=14, a is an integer from 2 to 13 and b is an integer from 1 to 12;
when a+b=15, a is an integer from 2 to 14 and b is an integer from 1 to 13;
when a+b=16, a is an integer from 2 to 15 and b is an integer from 1 to 14;
when d+e=8, d is an integer from 2 to 7 and e is an integer from 1 to 6;
when d+e=9, d is an integer from 2 to 8 and e is an integer from 1 to 7;
when d+e=10, d is an integer from 2 to 9 and e is an integer from 1 to 8;
when d+e=11, d is an integer from 2 to 10 and e is an integer from 1 to 9;
when d+e=12, d is an integer from 2 to 11 and e is an integer from 1 to 10;
when d+e=13, d is an integer from 2 to 12 and e is an integer from 1 to 11;
when d+e=14, d is an integer from 2 to 13 and e is an integer from 1 to 12.

In the mid-chain branched surfactant compounds described above, certain points of branching (e.g., the location along the chain of the R, R¹, and/or R² moieties in the above formula) are preferred over other points of branching along the backbone of the surfactant. The formula below illustrates the mid-chain branching range (i.e., where points of branching occur), preferred mid-chain branching range, and more preferred mid-chain branching range for mono-methyl branched alkyl A^{b} moieties.

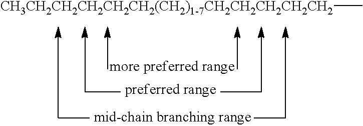

For mono-methyl substituted surfactants, these ranges exclude the two terminal carbon atoms of the chain and the carbon atom immediately adjacent to the —X—B group.

The formula below illustrates the mid-chain branching range, preferred mid-chain branching range, and more preferred mid-chain branching range for di-methyl substituted alkyl A^{b} moieties.

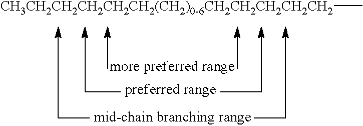

Additional suitable branched surfactants are disclosed in U.S. Pat. No. 6,008,181, U.S. Pat. No. 6,060,443, U.S. Pat. No. 6,020,303, U.S. Pat. No. 6,153,577, U.S. Pat. No. 6,093,856, U.S. Pat. No. 6,015,781, U.S. Pat. No. 6,133,222, U.S. Pat. No. 6,326,348, U.S. Pat. No. 6,482,789, U.S. Pat. No. 6,677,289, U.S. Pat. No. 6,903,059, U.S. Pat. No. 6,660,711, U.S. Pat. No. 6,335,312, and WO 9918929. Yet other suitable branched surfactants include those described in WO9738956, WO9738957, and WO0102451.

In some aspects, the branched anionic surfactant comprises a branched modified alkylbenzene sulfonate (MLAS), as discussed in WO 99/05243, WO 99/05242, WO 99/05244, WO 99/05082, WO 99/05084, WO 99/05241, WO 99/07656, WO 00/23549, and WO 00/23548.

In some aspects, the branched anionic surfactant comprises a C12/13 alcohol-based surfactant comprising a methyl branch randomly distributed along the hydrophobe chain, e.g., Safol®, Marlipal® available from Sasol.

Further suitable branched anionic detersive surfactants include surfactants derived from alcohols branched in the 2-alkyl position, such as those sold under the trade names Isalchem®123, Isalchem®125, Isalchem®145, Isalchem®167, which are derived from the oxo process. Due to the oxo process, the branching is situated in the 2-alkyl position. These 2-alkyl branched alcohols are typically in the range of C11 to C14/C15 in length and comprise structural isomers that are all branched in the 2-alkyl position. These branched alcohols and surfactants are described in US20110033413.

Other suitable branched surfactants include those disclosed in U.S. Pat. No. 6,037,313 (P&G), WO9521233 (P&G), U.S. Pat. No. 3,480,556 (Atlantic Richfield), U.S. Pat. No. 6,683,224 (Cognis), US20030225304A1 (Kao), US2004236158A1 (R&H), US6818700 (Atofina), US2004154640 (Smith et al), EP1280746 (Shell), EP1025839 (L'Oreal), U.S. Pat. No. 6,765,119 (BASF), EP1080084 (Dow), U.S. Pat. No. 6,723,867 (Cognis), EP1401792A1 (Shell), EP1401797A2 (Degussa AG), US2004048766 (Raths et al), U.S. Pat. No. 6,596,675 (L'Oreal), EP1136471 (Kao), EP961765 (Albemarle), U.S. Pat. No. 6,580,009 (BASF), US2003105352 (Dado et al), U.S. Pat. No. 6,573,345 (Cryovac), DE10155520 (BASF), U.S. Pat. No. 6,534,691 (du Pont), U.S. Pat. No. 6,407,279 (ExxonMobil), U.S. Pat. No. 5,831,134 (Peroxid-Chemie), U.S. Pat. No. 5,811,617 (Amoco), U.S. Pat. No. 5,463,143 (Shell), U.S. Pat. No. 5,304,675 (Mobil), U.S. Pat. No. 5,227,544 (BASF), U.S. Pat. No. 5,446,213A (MITSUBISHI KASEI CORPORATION), EP1230200A2 (BASF), EP1159237B1 (BASF), US20040006250A1 (NONE), EP1230200B1 (BASF), WO2004014826A1 (SHELL), U.S. Pat. No. 6,703,535B2 (CHEVRON), EP1140741B1 (BASF), WO2003095402A1 (OXENO), U.S. Pat. No. 6,765,106B2 (SHELL), US20040167355A1 (NONE), U.S. Pat. No. 6,700,027B1 (CHEVRON), US20040242946A1 (NONE), WO2005037751A2 (SHELL), WO2005037752A1 (SHELL), U.S. Pat. No. 6,906,230B1 (BASF), WO2005037747A2 (SHELL) OIL COMPANY.

Additional suitable branched anionic detersive surfactants include surfactant derivatives of isoprenoid-based polybranched detergent alcohols, as described in US 2010/0137649. Isoprenoid-based surfactants and isoprenoid derivatives are also described in the book entitled “Comprehensive Natural Products Chemistry: Isoprenoids Including Carotenoids and Steroids (Vol. two)”, Barton and Nakanishi, © 1999, Elsevier Science Ltd and are included in the structure E, and are hereby incorporated by reference.

Further suitable branched anionic detersive surfactants include those derived from anteiso- and iso-alcohols. Such surfactants are disclosed in WO2012009525.

Additional suitable branched anionic detersive surfactants include those described in US Patent Application Nos. 2011/0171155A1 and 2011/0166370A1.

Suitable branched anionic surfactants also include Guerbet-alcohol-based surfactants. Guerbet alcohols are branched, primary monofunctional alcohols that have two linear carbon chains with the branch point always at the second carbon position. Guerbet alcohols are chemically described as 2-alkyl-1-alkanols. Guerbet alcohols generally have from 12 carbon atoms to 36 carbon atoms. The Guerbet alcohols may be represented by the following formula: (R1)(R2)CHCH₂OH, where R1 is a linear alkyl group, R2 is a linear alkyl group, the sum of the carbon atoms in R1 and R2 is 10 to 34, and both R1 and R2 are present. Guerbet alcohols are commercially available from Sasol as Isofol® alcohols and from Cognis as Guerbetol.

The surfactant system disclosed herein may comprise any of the branched surfactants described above individually or the surfactant system may comprise a mixture of the branched surfactants described above. Furthermore, each of the branched surfactants described above may include a bio-based content. In some aspects, the branched surfactant has a bio-based content of at least about 50%, at least about 60%, at least about 70%, at least about 80%, at least about 90%, at least about 95%, at least about 97%, or about 100%.

Nonionic Surfactant

The composition may comprise at least one nonionic surfactant. In some aspects, the composition comprises from about 5% to about 30%, or from about 7% to about 25%, or from about 8% to about 25%, or from about 12% to about 22%, by weight of the cleaning composition, of a nonionic surfactant. Suitable nonionic surfactants include any of the conventional nonionic surfactant types typically used in liquid or gel cleaning products. These include alkoxylated fatty alcohols and amine oxide surfactants.

In some aspects, the nonionic surfactant comprises alcohol alkoxylate nonionic surfactants, such as ethoxylated nonionic surfactant. These materials are described, for example, in U.S. Pat. No. 4,285,841, Barrat et al, issued Aug. 25, 1981. The nonionic surfactant can be selected from the ethoxylated alcohols and ethoxylated alkyl phenols of the formula R(OC₂H₄)ₙOH, where R is selected from the group consisting of aliphatic hydrocarbon radicals containing from about 8 to about 18 carbon atoms and alkyl phenyl radicals in which the alkyl groups contain from about 8 to about 12 carbon atoms, and the average value of n is from about 1 to about 15. These surfactants, also known as alkoxylated fatty alcohols, are more fully described in, for example, U.S. Pat. No. 4,284,532, Leikhim et al, issued Aug. 18, 1981. In some aspects, the nonionic surfactant is selected from ethoxylated alcohols having an average of from about 10 to about 18 carbon atoms in the alcohol and an average degree of ethoxylation of from about 3 to about 12 moles of ethylene oxide per mole of alcohol.

In some aspects, the nonionic surfactant comprises a C12-C18 alkyl ethoxylate. A shorthand method of naming an alkyl ethoxylate refers to its number of carbons in the alkyl chain and its average number of ethoxylate (EO) groups. For example, an alkyl ethoxylate with from twelve to fourteen carbon atoms in its alkyl chain and an average of nine ethoxylate groups can be written as “C12, 14 EO9”. In some aspects, the C12-C18 alkyl ethoxylate is selected from the group consisting of: C12, 14 EO9; C12, 14 EO7; C12, 14 EO5; C12, 15 EO3; and mixtures thereof. In some aspects, the C12-C18 alkyl ethoxylate comprises a mixture of C12, 14 EO7 and C12, 15 EO3, and in some aspects, the molar ratio of C12, 14 EO7 to C12, 15 EO3 is about 2.2:1. In some aspects, the nonionic surfactant comprises: C12,13 EO1; C12,13 EO1.5; C12,13 EO2; C12,13 EO3; or mixtures thereof. In some aspects, the nonionic surfactant comprises C9,11 EO5; C11,16 EO7; C12,13 EO5; C12,13 EO6.5; C12,13 EO8; C12,13 EO9; C12,14 EO7; C12,14 EO8; C12,14 EO9; C14,15 EO5; C14,15 EO7; C14,15 EO8; C11 EO9; C12,14 EO9; C12,15 EO7; C12,15 EO10; C14,15 EO8; C14,15 EO9; C14,18 EO9; C10 EO3; C10 EO6; C12 EO3; C12 EO6; C12 EO9; or mixtures thereof.

In some aspects, the alkoxylated fatty alcohol materials have a hydrophilic-lipophilic balance (HLB) ranging from about 3 to about 17. In certain aspects, the HLB ranges from about 6 to 15, alternatively from about 8 to about 15. Alkoxylated fatty alcohol nonionic surfactants have been marketed under the tradenames Neodol and Dobanol by the Shell Chemical Company.

The nonionic surfactant may also comprise amine oxide. Amine oxides are materials which are often referred to in the art as “semi-polar” nonionics. Amine oxides have the formula: R(EO)ₓ(PO)_{y}(BO)ₙN(O)(CH₂R′)₂.qH₂O. In this formula, R is a relatively long-chain hydrocarbyl moiety which can be saturated or unsaturated, linear or branched, and can contain from 8 to 20 carbon atoms, or from 10 to 16 carbon atoms, or is alternatively a C₁₂-C₁₆ primary alkyl. R′ is a short-chain moiety, and may be selected from hydrogen, methyl and —CH₂OH. When x+y+z is different from 0, EO is ethyleneoxy, PO is propyleneneoxy and BO is butyleneoxy Amine oxide surfactants are illustrated by C₁₂₋₁₄ alkyldimethyl amine oxide.

Non-limiting examples of nonionic surfactants useful herein include: a) C₁₂-C₁₈ alkyl ethoxylates, such as, NEODOL® nonionic surfactants from Shell; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as Pluronic® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAE_{R}, wherein x 1-30, as discussed in U.S. Pat. No. 6,153,577, U.S. Pat. No. 6,020,303 and U.S. Pat. No. 6,093,856; f) Alkylpolysaccharides as discussed in U.S. Pat. No. 4,565,647 to Llenado, issued Jan. 26, 1986; specifically alkylpolyglycosides as discussed in U.S. Pat. No. 4,483,780 and U.S. Pat. No. 4,483,779; g) Polyhydroxy fatty acid amides as discussed in U.S. Pat. No. 5,332,528, WO 92/06162, WO 93/19146, WO 93/19038, and WO 94/09099; and h) ether capped poly(oxyalkylated) alcohol surfactants as discussed in U.S. Pat. No. 6,482,994 and WO 01/42408.

Anionic/Nonionic Combinations

Neutralized LAS at high concentrations can be hydrophobic and may precipitate from solution. Adding a nonionic surfactant (“NI”) that has a high HLB may contribute to a surfactant phase that does not precipitate from solution. However, in some aspects, if too much nonionic surfactant is added, the composition may not be phase stable. Therefore, the molar ratio of LAS:NI can be adjusted to produce concentrated, phase-stable cleaning compositions.

In some aspects, the multipurpose cleaning compositions of the present invention comprise combinations of anionic and nonionic surfactants in a molar ratio. The molar ratio of anionic surfactant to nonionic surfactant may be a molar ratio of linear alkyl benzene sulfonic acid to C12-18 alkyl ethoxylate. Typically, the molar ratio of anionic surfactant to nonionic surfactant is greater than about 1:1. In some aspects, the molar ratio of anionic surfactant to nonionic surfactant is from about 1.5:1 to about 5:1, or from about 1.8:1 to about 4.9:1, or from about 2.5:1 to about 3.5:1, or about 2.8:1. In some aspects, the molar ratio of anionic surfactant to nonionic surfactant is about 2.2:1.

Furthermore, it is believed that the presence of alkyl ethoxylate nonionic surfactants in a multipurpose cleaning composition can reduce the irritancy commonly associated with anionic surfactants. This irritancy reduction becomes especially advantageous in view of the multipurpose use of the cleaning compositions described herein, e.g., shampoo and laundry. The amount of eye irritation of any particular multipurpose cleaning composition can be quantified using a standard eye irritancy test method well known to a person of ordinary skill. See, for example, The resultant eye irritation dosage can then be used as a basis for comparing the multipurpose cleaning compositions with other products, such as market shampoo products. In a typical standard test, eye irritation is determined by exposing a batch of test cells (ocular cells, for example) to a cleaning composition and determining, through experimentation, the dosage of cleaning composition (in units such as mg/mL) at which the metabolic rate of the test cells is reduced in half. Thus, the greater the dosage value, the less irritating the cleaning composition is to the eyes. Market shampoo products typically have eye irritation dosages of at least 0.5 mg/mL, alternatively at least 0.6 mg/mL. In some aspects, the concentrated composition of the present invention has eye irritation dosages of at least 0.5 mg/mL or of at least 0.6 mg/mL. In some aspects, when one part of the concentrated composition is diluted by 3 parts water, the resulting composition has an eye irritation dosage of at least 0.5 mg/mL or of at least 0.6 mg/mL.

### Organic Acid

The multipurpose cleaning compositions disclosed herein comprise at least one organic acid, typically in the form of an organic carboxylic acid or polycarboxylic acid. Examples of organic acids that may be used include: lactic acid, acetic acid, formic acid, adipic acid, aspartic acid, carboxymethyloxymalonic acid, carboxymethyloxysuccinic acid, citric acid, glutaric acid, hydroxyethyliminodiacetic acid, iminodiacetic acid, maleic acid, malic acid, malonic acid, oxydiacetic acid, oxydisuccinic acid, succinic acid, sulfamic acid, tartaric acid, tartaric-disuccinic acid, tartaric-monosuccinic, and mixtures thereof. In some aspects, the organic acid is selected from lactic acid, acetic acid, formic acid, citric acid, and mixtures thereof. In some aspects, the organic acid is acetic acid. The composition may comprise organic acids that can also serve as builders, such as citric acid.

The organic acid may comprise a low-weight acid, for example, an acid having a molecular weight of less than 210 g/mole. In some aspects, each organic acid in the multipurpose cleaning composition has fewer than 9 carbon atoms, alternatively 6 or fewer carbon atoms, alternatively fewer than 6 carbon atoms. In some aspects, each organic acid in the multipurpose cleaning composition has fewer than 4 carbon atoms or fewer than 3 carbon atoms. Specific non-limiting examples of organic acids having fewer than 3 carbon atoms include formic acid and acetic acid.

In some aspects, the multipurpose cleaning composition of the present invention comprises from about 0.5% to about 8%, or from about 1% to about 6%, or from about 2% to about 4%, or about 2%, by weight of the composition, of the organic acid.

### Adjuncts

The compositions of the present invention may comprise one or more additional adjuncts such as dyes, bleaching agents, hueing dyes, chelants, radical scavengers, perfumes, fluorescent whitening agents, suds supressors, soil suspension polymers, soil release polymers, dye-transfer inhibitors, fabric softening additives, rheology modifiers, structurants, builders, enzymes, preservatives, solvents, clay soil removal/anti-redeposition agents, and/or other benefit agents. In some aspects, the compositions are substantially free of some or all of the adjuncts listed below. In some aspects, the composition comprises from about 0.01% to about 50% of the adjuncts listed herein.

Dyes

The compositions of the present invention may contain a dye to either provide a particular color to the composition itself (non-fabric substantive dyes) or to provide a hue to the fabric (hueing dyes). In one aspect, the compositions of the present invention may contain from about 0.0001% to about 0.01% of a non-fabric substantive dye and/or a hueing dye. Examples of dyes useful herein include Basic Violet 3 (CI 42555) and Basic Violet 4 (CI 42600), both commercially available from Standard Dyes (High Point, N.C.), and Liquitint Violet 200 and Liquitint Violet Blue 297 from Milliken Company. In some aspects, the composition is substantially free of hueing dye.

Bleaching Agent

The compositions of the present invention may comprise a bleaching agent. In one aspect, the compositions of the present invention may contain from about 0.10% to about 10%, by weight of the composition, of a bleaching agent. Bleaching agents useful herein include hydrogen peroxide or peroxyacids such as 6-phthalimidoperoxyhexanoic acid. In some aspects, the compositions may comprise a bleach activator, such as TAED or NOBS. When the composition is in a unit dose form having at least two or at least three compartments, the bleaching agent may be in a different compartment than the surfactant.

Chelants

The compositions of the present invention may comprise a chelant. Chelants useful herein include DTPA, HEDP, DTPMP, polyfunctionally-substituted aromatic chelants such as 1,2-dihydroxy-3,5-disulfobenzene (tiron), dipicolinic acid, and mixtures thereof.

Radical Scavenger

The compositions of the present invention may comprise a radical scavenger which may be used with liquid hydrogen peroxide to provide stability. Radical scavengers useful herein include trimethoxybenzoic acid.

Perfumes

Certain surfactants, organic acids, or other adjuncts may have undesirable odors. The smell of perfume may also signify cleanliness to the consumer. Therefore, the compositions of the present invention may comprise perfume. The perfume should be an acid-stable perfume, the selection of which is within the skill of one of ordinary skill in the art. The compositions may comprise from about 0.1% to about 5%, or from about 0.5% to about 4%, or from about 1% to about 3%, or from about 2% to about 2.5%, by weight of the composition, of perfume.

In some aspects, the compositions disclosed herein may comprise a perfume delivery system. Suitable perfume delivery systems, methods of making certain perfume delivery systems, and the uses of such perfume delivery systems are disclosed in USPA 2007/0275866 A1. Such perfume delivery system may be a perfume microcapsule. The perfume microcapsule may comprise a core that comprises perfume and a shell, with the shell encapsulating the core. The shell may comprise a material selected from the group consisting of aminoplast copolymer, an acrylic, an acrylate, and mixtures thereof. The aminoplast copolymer may be melamine-formaldehyde, urea-formaldehyde, cross-linked melamine formaldehyde, or mixtures thereof. The perfume microcapsule's shell may be coated with one or more materials, such as a polymer, that aids in the deposition and/or retention of the perfume microcapsule on the site that is treated with the composition disclosed herein. The polymer may be a cationic polymer selected from the group consisting of polysaccharides, cationically modified starch, cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides, poly vinyl amine, copolymers of poly vinyl amine and N-vinyl formamide, and mixtures thereof. The perfume microcapsule may be friable and/or have a mean particle size of from about 10 microns to about 500 microns or from about 20 microns to about 200 microns. In some aspects, the composition comprises, based on total composition weight, from about 0.01% to about 80%, or from about 0.1% to about 50%, or from about 1.0% to about 25%, or from about 1.0% to about 10% of perfume microcapsules. Suitable capsules may be obtained from Appleton Papers Inc., of Appleton, Wis. USA. Formaldehyde scavengers may also be used in or with such perfume microcapsules.

Fluorescent Whitening Agent

The compositions of the present invention may comprise a fluorescent whitening agent. Fluorescent whitening agents useful herein include those that are compatible with an acidic environment such as Tinopal CBS-X.

Suds Supressors

The compositions of the present invention may comprise a suds suppressor. When suds suppressors are present, the composition comprises from about 0.001% to about 0.02% by weight of the composition of suds suppressor. Examples of suppressors useful herein include silica/silicone type, silicone oil, branched alcohols, and mixtures thereof.

Soil Suspension Polymers

The compositions of the present invention may comprise soil suspension polymers. Soil suspension polymers include, without limitation, PEI ethoxylates, HMDA diquat ethoxylates, sulfonated derivatives, and hydrophobically modified anionic copolymers. In some aspects, the composition comprises from about 0.001% to about 0.5% by weight of the composition of soil suspension polymers.

Soil Release Polymers

The compositions of the present invention may comprise soil release polymers. Soil release polymers include, without limitation, a PET alkoxylate short block copolymer, anionic derivative, or mixture thereof. In some aspects, the composition comprises from about 0.001% to about 0.5% by weight of the composition of soil release polymers.

Dye Transfer Inhibitors

The compositions of the present invention may comprise a dye transfer inhibitor and/or a dye fixative. Examples of dye transfer inhibitors useful herein include polyvinylpyrrolidone, poly-4-vinylpyridine-N-oxide, copolymers of N-vinyl-2-pyrrolidone and N-vinylimidazole and mixtures thereof. Useful dye fixatives for this application are disclosed in U.S. Pat. No. 6,753,307.

Fabric Softening Additives

In some aspects, the compositions of the present invention may comprise a fabric softening additive. Examples of fabric softening additives useful herein include alkyl quaternary ammonium compounds, ester quaternary ammonium compounds, silicones, cationic silicones, and mixtures thereof.

Rheology Modifiers

In some aspects, the compositions of the present invention may comprise a rheology modifier. Useful rheology modifiers include methylcellulose, hydroxypropylmethylcellulose, xanthan gum, gellan gum, guar gum and hydroxypropyl guar gum, succinoglycan, and trihydroxystearin. Further suitable rheology modifiers include methylcellulose and hydroxypropylmethylcellulose thickeners available under the Methocel® trade name from Dow Chemical and Alcogum L520 from Akzo Nobel. In some aspects, the cleaning compositions of the present invention comprise from about 0.01% to about 1%, or from about 0.02% to about 0.75%, or from about 0.05% to about 0.5%, by weight of the cleaning composition, of a rheology modifier.

In some aspects, the compositions of the present invention are substantially free of rheology modifiers. As used herein, surfactants are not to be understood as “rheology modifiers.” In some aspects, the compositions comprise less than 0.01%, by weight of the composition, of rheology modifiers.

### Structurant

The compositions of the present invention generally rely on internal structuring rather than external structuring. By “internal structuring” it is meant that the detergent surfactants are relied on for structuring effect. Here, as described above, it has been surprisingly discovered that a concentrated multipurpose cleaning composition that has a desirable viscosity and is readily dilutable may be obtained by selecting certain surfactants, in certain concentrations, and at certain ratios to each other in a low-pH system. In the opposite sense, “external structuring” means structuring which relies on a nonsurfactant, e.g., crystallized glyceride(s) as structurants, including, but not limited to, hydrogenated castor oil, to achieve the desired rheology and particle suspending power.

In some aspects, the compositions of the present invention are substantially free of external structuring systems. In some aspects, the compositions are substantially free of hydroxyfunctional crystalline materials, including but not limited to hydrogenated castor oil. In some aspects, the compositions comprise less than 0.01%, or less than 0.001%, by weight of the composition, of hydroxyfunctional crystalline materials, or of hydrogenated castor oil. When additional structuring is desired, the composition may comprise from about 0.01% to about 6%, by weight of the composition, of hydroxyfunctional crystalline materials.

Enzymes

In some aspects, the compositions of the present invention are substantially free of enzymes. Enzymes are known sensitizers and, therefore may be disadvantageous within a multipurpose cleaning product suitable for use on hair and skin in addition to its use on laundry. The correct choice of type and level of surfactant and organic acid, therefore, is important to providing both good cleaning and mild use conditions in the absence of enzymes. In some aspects, the composition comprises from about 0.00001% to about 0.01% active enzymes that are stable and effective in a low-pH environment.

Builders

The compositions typically contain low levels of builders. In some aspects, the compositions are substantially free of builders except insofar as the at least one organic acid may function in such a manner. Underbuilt cleaning compositions in general may be advantageous both for cost savings and to preserve the ecology, such by minimizing additional water pollution and damage to vegetation where the compositions may be disposed of directly on the ground or into water supplies. It is believed also that underbuilt cleaning compositions are milder to the skin and hair, particularly because they lack aggressive salts and crystalline, abrasive materials.

Preservatives

The compositions of the present invention may comprise a preservative. Suitable preservatives may be selected by one of ordinary skill in the art and may include Proxel (available from Arch Chemicals/Lonza). When present, the preservative is present in an amount of from about 0.01% to about 2.0%, or about 0.1% to about 1.0%, or about 0.1% to about 0.3%, by weight of the composition. In some aspects, the compositions comprise less than 0.01% of a preservative. In some aspects, the compositions are substantially free of preservatives.

Solvents

In some aspects, the composition comprises water and is substantially free of organic solvent. However, in some aspects, an organic solvent may be preferred to aid with solubilizing the components of the composition, particularly if the composition is encapsulated in a water-soluble film or pouch. Therefore, in some aspects, the composition may comprise organic solvent. In some aspects, the organic solvents are selected from 1,2-propanediol, ethanol, glycerol, dipropylene glycol, methyl propane diol and mixtures thereof. Other lower alcohols, such C1-C4 alkanolamines, for example monoethanolamine and/or triethanolamine, can also be used. In some aspects, the composition comprises from about 0.1% to about 70%, or from about 1% to about 50%, or from about 5% to about 25%, by weight of the composition, of organic solvent.

Clay Soil Removal/Anti-Redeposition Agents

In some aspects, the composition is substantially free of clay soil removal/anti-redeposition agents. However, in some aspects, such an agent may be used to improve the cleaning benefits of the cleaning composition, especially if it is anticipated that the composition will be used in wash water that is polluted or reused. Therefore, in some aspects, the compositions of the present invention can also optionally contain water-soluble ethoxylated amines having clay soil removal and anti-redeposition properties. In some aspects, the concentrated compositions comprise about 0.005% to about 5% by weight of the water-soluble ethoxylates amines. Exemplary clay soil removal and anti-redeposition agents are described in U.S. Pat. Nos. 4,597,898; 548,744; 4,891,160; European Patent Application Nos. 111,965; 111,984; 112,592; and WO 95/32272.

### Composition pH

The concentrated compositions of the present invention are low-pH compositions. In other words, the concentrated compositions are acidic, meaning that the neat pH is below 7. Unless otherwise stated, the pH of the composition is measured neat.

Neat pH

The pH of the concentrated cleaning composition (measured neat) is less than 7. In some aspects, the pH of the cleaning composition (measured neat) is from about 2 to about 6.9, or from about 2 to about 6.5, or from about 2 to 6, or from about 3 to about 5, or from about 4 to about 5, or about 4.4. In some aspects, the composition comprises an alkalizing agent in an amount suitable to obtain a desirable final pH of the composition. In some aspects, the alkalizing agent is a hydroxide of an alkali metal or an alkali earth metal, such as sodium hydroxide, or an alkanolamine, such as methanolamine (MEA).

pH in Wash Water

In some aspects, the cleaning compositions of the present invention are capable of delivering a pH to the wash water (“wash water pH”), when the cleaning composition is added to the wash water (e.g., of a standard laundry bucket) of less than 7, or less than about 6.5, or less than about 6.2, or less than about 6.0. In practical terms, the cleaning compositions of the present invention are provided to the wash water in a sufficient amount such that the wash water contains from about 0.02% to about 4%, by weight of the wash water, of the cleaning composition. In one aspect, the wash water contains from about 0.03% to about 3%, by weight of the wash water, of the cleaning composition, alternatively from about 0.04% to about 2% (about 400 to about 20000 ppm). In some aspects, the composition may be diluted up to 700-fold with water to form a wash liquor; in such aspects, the pH of the wash liquor is from about 4 to less than about 7, or from about 4.5 to about 6.9, or 5 to about 6.5, or about 6.

### Viscosity

Unless specifically indicated to the contrary, all stated viscosities are those measured at a shear rate of 1 s⁻¹ and at a temperature of 25.0° C. Viscosity can be measured with any suitable viscosity-measuring instrument, e.g., an AR2000 viscometer (TA Instruments of New Castle, Del.) using an acrylic 60 mm, 2° flat cone at a shear rate of 1 s⁻¹.

In neat form, the concentrated cleaning compositions of the present invention may have viscosities in the range of from about 500 mPa*s (milli Pascal seconds) to about 13,000 mPa*s at 1 s⁻¹. In some aspects, the compositions have viscosities in the range of from about 750 mPa*s to about 7,500 mPa*s, or from about 1000 mPa*s to about 5,100 mPa*s, or from about 3000 mPa*s to about 4000 mPa*s, at 1 s⁻¹. In some aspects, at 10 s⁻¹, the cleaning compositions have viscosities in the range of from about 200 mPa*s to about 1500 mPa*s, or from about 250 mPa*s to about 1300 mPa*s, or from about 300 to about 825 mPa*s. The concentrated cleaning compositions of the present invention may be in the form of a gel, pourable gels, non-pourable gels, or heavy-duty liquids.

### Diluted Composition

The concentrated compositions of the present disclosure may be diluted with water or another suitable liquid to form a diluted composition. The compositions may be diluted by a supplier prior to or after shipment, by a vendor prior to sale or use, or by a consumer or commercial establishment prior to or during use.

In some aspects, the diluted composition may be formed by diluting 1 part (by weight or volume) of the composition with up to about 2, or up to about 3, or up to about 4, or up to about 5, or up to about 10 or more parts (by weight or volume) water or another suitable liquid. In some aspects, the diluted composition may be formed by diluting 1 part of the concentrated composition with from about 1 to about 6 or from about 2 to about 4 parts water or another suitable liquid. In some aspects, the concentrated composition is diluted with water.

The diluted composition may have a viscosity in the range of from about 25 mPa*s to about 13,000 mPa*s at 1 s⁻¹. In some aspects, the diluted composition has a viscosity in the range of from about 750 mPa*s to about 7,500 mPa*s, or from about 1000 mPa*s to about 5100 mPa*s, or from about 3000 mPa*s to about 4000 mPa*s, at 1 s⁻¹. In some aspects, the difference between the viscosity of the concentrated composition and the viscosity of the diluted composition is no more than about 5000 mPa*s, or no more than about 3000 mPa*s, or no more than about 1000 mPa*s, or no more than about 500 mPa*s, or no more than about 100 mPa*s at 1 s⁻¹.

In some aspects, the pH of the diluted composition (measured neat) is from about 2 to about 6.9, or from about 2 to about 6.5, or from 2 to about 6, or from about 3 to about 5.

### Phase Stable

In some aspects, the concentrated compositions of the present invention are phase stable, as determined by the test method described below.

### Method of Using

The present disclosure provides a method for treating a surface, for example, fabric, hair, skin, a hard surface, or other surface, with the compositions disclosed herein. In some aspects, the method comprises the steps of optionally washing and/or rinsing the surface, contacting the surface with the presently disclosed composition, then optionally washing and/or rinsing the surface. Following the treatment of the surface with the disclosed composition, the surface may optionally be dried. The surface may be contacted with the composition in neat form or in dilute form; in some aspects, the composition may be mixed with wash water. The method for treating a surface may be performed manually, such as by hand washing or bathing, or in an automated fashion, such as by a machine, e.g., a dishwasher or a washing machine.

In some aspects, the method comprises the steps of contacting a surface with the cleaning composition and washing the surface. In some aspects, the surface is selected from fabric, hair, skin, or a hard surface. In some aspects, the method further comprises the step of diluting the composition. In some aspects, the dilution of the composition occurs prior to contacting the surface or, alternatively, while the composition is in contact with the surface.

### EXAMPLES

Table 1 below provides some non-limiting examples of compositions according to the present disclosure. The examples are prepared as follows.

Deionized water (Crystal Springs of Santa Cruz, Calif.) is added to a reaction vessel underneath an RW 20 Digital Overhead Stirrer from IKA Works (VWR of Radnor, Pa.). Acetic acid (BDH Aristar from VWR of Radnor, Pa.), formic acid (Harris & Ford, LLC of Indianapolis, Ind.), HLAS (Stepan of Northfield, Ill.), and NI24-9 (Huntsman Corp of Salt Lake City, Utah) are then successively added to the reaction vessel. Sodium hydroxide (Formosa Plastics Corp of Point Comfort, Tex.) is then added to bring the pH of the solution to about 4.4. Perfume is added, and the remaining deionized water is added to balance to 100%.

### Measuring pH

The pH of the compositions is measured using a sympHony SP70P pH meter (VWR of Radnor, Pa.). The pH meter is calibrated according to the VWR sympHony Meter User Guide using calibration solutions of pH=4, 7, and 10, respectively. Once the pH meter is calibrated, the probe is rinsed with deionized water, placed in the neat (undiluted) liquid, and the value is recorded.

### Determining Viscosity

Viscosity measurements are performed using the AR2000 rheometer/viscometer (TA Instruments of New Castle, Del.) and an acrylic 60 mm diameter, 2° flat cone, operated in controlled shear rate mode, using TA Rheology Advantage software (version V5.7.0) The composition may be mixed to increase homogeneity and reduce air bubbles. If there are particles in the composition which have a diameter of >10% of the gap between the plate and cone (ie >60 μm), then those particles are to be omitted or removed from the sample prior to measuring viscosity. The viscometer is zeroed in accordance with the operating manual for the instrument. The cone is raised to the up position. Enough of the composition to ensure uniform coverage once the top geometry with acrylic cone has been lowered and at least 1 mm of product composition is pressed out slightly around the entire circumference of the cone is transferred to the center or near the center of the stationary geometry (bottom plate) with a pipette. Once the product is transferred to the stationary geometry, the top geometry with acrylic cone is lowered to the down position. The gap between the plates (compression distance) is set at 600 μm, and the compression velocity is set at 1,000 μm/s. The gap zero mode is set at Normal force mode with a value of 1.0 N, and the Sample Compression is set at linear mode with a value of 1.0 N. The miscellaneous gap settings include the fine velocity set at 1,000 μm/s and the coarse velocity set at 3,000 μm/s. A time period of 60 s is then allowed to pass in order to allow the composition to reach 25.0° C. and equilibrate at this temperature. Once the composition is equilibrated, rotation of the cone is begun and measurements are taken at 25.0° C. at a shear rate of 1 s⁻¹. Record the measurement taken at 15 s. Data is also collected at 25.0° C. at 10 s⁻¹ with all other conditions unchanged. The above is modeled after ASTM D7395-07.

### Determining Stability

In order to test a composition for stability/phase separation, the composition is loaded into several 10 mL glass vials and at least 1 filled and sealed vial is placed in storage for each of the three specified temperatures, namely: 10° C., 25° C., and 40° C., for 7 days. After 7 days at a specified temperature, the composition in each vial is examined visually for phase separation. A composition is determined to be phase stable at a particular temperature if, after the 7 days, (i) the composition remains free from splitting into two or more layers or (ii) it splits into layers but the major layer comprises at least 90% or at least 95% of the composition by weight.

### Determining Ease of Dilution

If there are particulates visible in the composition when viewed by eye, then the particulates are omitted or removed prior to determining the composition's ease of dilution. 5 g of the composition is placed into a 50 mL Becton Dickinson Falcon Conical Centrifuge tube (VWR of Radnor, Pa.) followed by 15 g of 21° C.+/−1° C. deionized water (Crystal Springs of Santa Cruz, Calif.). The centrifuge tube is capped, and slowly inverted multiple times to create gentle mixing. The tube is inverted either 50 times through 180 degrees in a reciprocal motion, or 25 times through 360 degrees in a continuous motion, with all the inversions completed within a time span of 1.5 to 3.0 mins. These inversions utilize only the force of gravity to create mixing, and are conducted either by mounting the tube on a clip bar style Shaker/Rotator, such as the Labquake Tube model 4003110Q (Thermo Scientific of Waltham, Mass.), or are conducted by hand using gentle wrist and arm motion to create similar, gentle 180 degree reciprocal inversions. If conducting the inversions by hand, it is important to ensure that no additional force, agitation or momentum is applied beyond that which is generated by gravity during simple inversion Immediately after all inversions are complete, the appearance of the formula is visually observed at a distance of 30 cm and assessed for homogeneity. If the diluted composition appears homogenous at the end of the inversions, it is considered to be a “pass”, however, if it appears to contain undissolved matter, such as suspended particulates or formula residue for example, it is considered a “fail”. Use slight agitation during the observation to assist in the visual detection of residual composition or other undissolved matter.

TABLE 1

| Component | Purpose | Example 1 | Example 2 | Example 3 | Example 4 | Example 5 |
|---|---|---|---|---|---|---|
| Neutralized C11.8 | Anionic | 25.1% | 29% | 32% | 34.2% | 38.5% |
| linear alkyl | Surfactant/Cleaning | | | | | |
| benzene sulfonic | | | | | | |
| acid | | | | | | |
| C12,14 EO9 | Nonionic | 15.5% | 17.5% | 20% | 12% | 8% |
| nonionic | Surfactant/Cleaning | | | | | |
| Total Surfactant | | 40.6% | 46.5% | 52% | 46.2% | 46.5% |
| Surfactant | | 2.8 | 2.8 | 2.8 | 4.9 | 8.3 |
| Molar Ratio | | | | | | |
| (anionic:nonionic) | | | | | | |
| Acetic Acid | Acidulant | 2-4% | 2-3% | 2-4% | 2% | 2% |
| Formic Acid | Acidulant | 0.4% | 0.4% | 0.4% | 0.4% | 0.4% |
| Perfume | Aesthetics | 2.4% | 2.4% | 2.4% | 2.4% | 2.4% |

| | | |
|---|---|---|
| Sodium Hydroxide | pH adjust | As needed to adjust to pH 4.4 |
| Minors/Water | | Balance to 100% |

| | | | | | |
|---|---|---|---|---|---|
| Property | | | | | |
| Neat pH | 4.4 | 4.4 | 4.4 | 4.4 | 4.4 |
| Stability | Stable | Stable | Stable | Stable | Stable |
| Viscosity (1^{s-1}) | 1,000-2,000 mPa · s | 3,300-3,800 mPa · s | 10,000 mPa · s | 3,200 mPa · s | 53,000 mPa · s |
| Viscosity (10^{s-1}) | 300-400 mPa · s | 740-825 mPa · s | 1,420 mPa · s | 715 mPa · s | — |
| Ease of Dilution | Pass | Pass | Fail | Pass | Fail |

| Component | Purpose | Example 6 | Example 7 | Example 8 | Example 9 |
|---|---|---|---|---|---|
| Neutralized C11.8 linear | Anionic | 23.5% | 44% | 26.7% | 44% |
| alkyl benzene sulfonic | Surfactant/Cleaning | | | | |
| acid | | | | | |
| C12,14 EO9 nonionic | Nonionic | 22% | 9% | 25% | 9% |
| | Surfactant/Cleaning | | | | |
| Total Surfactant | | 45.5% | 53% | 51.7% | 53% |
| Surfactant | | 1.8 | 8.3 | 1.8 | 8.3 |
| Molar Ratio | | | | | |
| (anionic: nonionic) | | | | | |
| Acetic Acid | Acidulant | 2% | 2% | 2% | 4% |
| Formic Acid | Acidulant | 0.4% | 0.4% | 0.4% | 0.4% |
| Perfume | Aesthetics | 2.4% | 2.4% | 2.4% | 2.4% |

| | | |
|---|---|---|
| Sodium Hydroxide | pH adjust | As needed to adjust to pH 4.4 |
| Minors/Water | | Balance to 100% |

| | | | | |
|---|---|---|---|---|
| Property | | | | |
| Neat pH | 4.4 | 4.4 | 4.4 | 4.4 |
| Stability | Not | Not stable | Stable | Stable |
| | Stable | | | |
| Viscosity (1^{s-1}) | 1,700 mPa · s | 95,000 mPa · s | 5,010 mPa · s | 11,500 mPa · s |
| Viscosity (10^{s-1}) | 490 mPa · s | — | 1,300 mPa · s | 6,770 mPa · s |
| Ease of Dilution | Pass | Fail | Pass | Fail |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular aspects of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multipurpose liquid cleaning composition comprising:
a. from about 20% to about 55% by weight of the cleaning composition of at least one anionic surfactant;
b. from about 5% to about 30% by weight of the cleaning composition of at least one nonionic surfactant; and
c. from about 0.5% to about 8% by weight of the cleaning composition of at least one organic acid, wherein each organic acid in the composition has fewer than 9 carbon atoms;
wherein the cleaning composition comprises from about 25% to about 60% by weight of the cleaning composition of surfactant; and
wherein the cleaning composition has a neat pH of from about 2 to about 6.9.

2. The composition of claim 1, wherein each organic acid has 6 or fewer carbons.

3. The composition of claim 2, wherein at least one of the organic acids is selected from the group consisting of acetic acid, formic acid, lactic acid, citric acid, and mixtures thereof.

4. The composition of claim 2, wherein the multipurpose cleaning composition comprises from about 2% to about 4% by weight of the multipurpose cleaning composition of organic acid.

5. The composition of claim 1, wherein the anionic surfactant comprises linear alkyl benzene sulfonic acid.

6. The composition of claim 1, wherein the anionic surfactant is present in an amount of from about 23.5% to about 44% by weight of the multipurpose liquid cleaning composition.

7. The composition of claim 1, wherein the nonionic surfactant comprises C12-C18 alkyl ethoxylate.

8. The composition of claim 7, wherein the C12-C18 alkyl ethoxylate is selected from the group consisting of: C12, 14 EO9; C12, 14 EO7; C12, 14 EO5; C12, 15 EO3; and mixtures thereof.

9. The composition of claim 8, wherein the C12-C18 alkyl ethoxylate is a mixture of C12, 14 EO7 and C12, 15 EO3 present in a molar ratio of about 2.2:1.

10. The composition of claim 1, wherein the nonionic surfactant is present in an amount of from about 8% to about 25% by weight of the multipurpose liquid cleaning composition.

11. The composition of claim 1, wherein the total amount of surfactant is between about 40% and about 52%.

12. The composition of claim 1, wherein the composition has a molar ratio of anionic surfactant to nonionic surfactant of greater than about 1:1.

13. The composition of claim 12, wherein the molar ratio of anionic surfactant to nonionic surfactant is from about 1.5:1 to about 5:1.

14. The composition of claim 1, wherein the composition has a viscosity of from about 500 mPa*s to about 13,000 mPa*s at 1 s⁻¹ and at 25.0° C.

15. The composition of claim 1, wherein the neat pH of the composition is from about 3 to 5.

16. The composition of claim 1, wherein the composition further comprises an adjunct selected from the group consisting of non-fabric substantive dye, hueing dye, bleaching agent, chelant, radical scavenger, perfume, fluorescent whitening agent, suds supressor, soil suspension polymer, soil release polymer, dye transfer inhibitor, fabric softening additive, rheology modifier, structurant, enzyme, builder, preservative, solvent, clay soil removal/anti-redeposition agent, and mixtures thereof.

17. A method of cleaning a surface, comprising the steps of:
contacting the surface with the composition of claim 1; and
washing the surface.

18. The method according to claim 17, further comprising the step of diluting the composition of claim 1.

19. A diluted composition, comprising:
1 part of the cleaning composition of claim 1; and
up to about 10 parts water.

20. A multipurpose liquid cleaning composition consisting essentially of:
a. from about 21% to about 53%, by weight of the composition, of anionic surfactant comprising alkyl benzene sulfonic acids and their salts;
b. from about 7% to about 25%, by weight of the composition, of nonionic surfactant comprising C12-C18 alkyl ethoxylates;
c. from about 1% to about 6%, by weight of the composition, of organic acid, wherein the organic acid has 6 or fewer carbons;
d. optionally, perfume;
e. optionally, dye; and
f. water;
wherein the multipurpose liquid cleaning composition has a neat pH of from about 3 to about 5.
